(19) United States
(12) Patent Application Publication
(10) Pub. No.: US 2025/0210281 A1
(43) Pub. Date: Jun. 26, 2025

(54) ELECTROCHEMICAL DEVICE AND METHOD FOR MANUFACTURING ELECTROCHEMICAL DEVICE

(71) Applicant: Panasonic Intellectual Property Management Co., Ltd., Osaka (JP)

(72) Inventors: Nao MIYAGUCHI, Osaka Fu (JP); Nobutaka TAKEDA, Osaka Fu (JP); Mitsuhiro FUJITA, Osaka Fu (JP); Yusuke NAKAMURA, Osaka Fu (JP)

(73) Assignee: Panasonic Intellectual Property Management Co., Ltd., Osaka (JP)

(21) Appl. No.: 18/849,184

(22) PCT Filed: Mar. 20, 2023
(86) PCT No.: PCT/JP2023/010877

§ 371 Date: Sep. 20, 2024

(30) Foreign Application Priority Data
Mar. 24, 2022 (JP) 2022-048641
Mar. 30, 2022 (JP) 2022-056409
Mar. 30, 2022 (JP) 2022-056562

(51) Int. Cl. H01G 11/86; H01G 11/28; H01G 11/34; H01G 11/50; H01G 11/52; H01G 13/02

(52) U.S. Cl. CPC H01G 11/86; H01G 11/28; H01G 11/34; H01G 11/50; H01G 11/52; H01G 13/02

(57) ABSTRACT

A disclosed electrochemical device includes a wound body that is constituted of a belt-shaped positive electrode containing active carbon as a positive electrode active material, a belt-shaped negative electrode, and a belt-shaped separator. The wound body includes a winding shaft part that is formed by being sandwiched between winding shafts and a winding part that is connected to the winding shaft part. The winding shaft part includes a portion of one end side of the negative electrode and a portion of one end side of the separator. The positive electrode, the negative electrode, and the separator are wound in the wound body such that both surfaces of the positive electrode face the negative electrode.

### TECHNICAL FIELD

The present disclosure relates to an electrochemical device and a manufacturing method of the electrochemical device.

### BACKGROUND ART

An electrical double layer capacitor, which is an example of an electrochemical device, has a long life, is capable of rapid charging, and has excellent output characteristics. Therefore, the electrical double layer capacitor is widely used for a backup power source and the like. Examples of the electrochemical device include a wound-type electrochemical device and a stacked-type electrochemical device. Conventionally, various wound-type power storage devices have been proposed.

PTL 1 (Japanese Laid-Open Patent Publication No. 2017-188541) discloses a “manufacturing method of a capacitor including a capacitor element formed by stacking a separator between an anode foil and a cathode foil and winding these components, the method comprising the steps of forming a support part that supports the anode foil by integrating the anode foil into the separator, and winding the anode foil, the cathode foil, and the separator while applying a tensile force acting on the wound separator to the anode foil via the support part”.

PTL 2 (Japanese Laid-Open Patent Publication No. 2020-188193) discloses a “wound-type capacitor including a capacitor element and an exterior case in which the capacitor element is stored in a state of being impregnated with an electrolyte, wherein the capacitor element has a wound body formed by winding an electrode foil to be an anode and an electrode foil to be a cathode with a sheet-like separator in between, and an element fastening tape that is wound around the outer periphery of the wound body to maintain the wound state of the electrode foil to be an anode, the electrode foil to be a cathode, and the separator, and the element fastening tape is arranged such that, at one end of the element fastening tape, a winding start end face of the element fastening tape faces, out of the electrode foil to be an anode and the electrode foil to be a cathode, a winding end face of the electrode foil arranged radially inside the wound body, in the winding direction of the wound body, and the other end of the element fastening tape is fixed to the surface of the element fixing tape”.

### CITATION LIST

### Patent Literatures

PTL 1: Japanese Laid-Open Patent Publication No. 2017-188541
PTL 2: Japanese Laid-Open Patent Publication No. 2020-188193

### SUMMARY OF INVENTION

### Technical Problem

Currently, there is a demand for a high-reliability wound-type electrochemical device that can be manufactured with good yield. In this situation, an object of the present disclosure is to provide a high-reliability wound-type electrochemical device that can be manufactured with good yield.

In an electrochemical device that includes a wound body, the wound body may become loosened (unwind) and lose its original state at the time of production. In particular, when the wound body expands due to impregnation with an electrolytic solution, the wound body is likely to unwind. When the wound body unwinds, the distance between the electrodes varies. This results in problems such as increased internal resistance and increased variation in performance.

Therefore, there is currently a demand for an electrochemical device in which unwinding of the wound body is unlikely to occur. An object of the present disclosure is to provide an electrochemical device in which unwinding of the wound body is less likely to occur.

Novel features of the present invention are set forth in the appended claims, but the present invention, both in terms of structure and content, together with other objects and features of the present invention, will be better understood from the following detailed description in conjunction with the drawings.

### Solution to Problem

An aspect of the disclosure relates to a first manufacturing method of an electrochemical device. The first manufacturing method is a manufacturing method of an electrochemical device that includes a wound body constituted of a belt-shaped positive electrode containing active carbon as a positive electrode material, a belt-shaped negative electrode, and a belt-shaped separator interposed between the positive electrode and the negative electrode, wherein the first manufacturing method includes a step (i) of sandwiching a portion of one end side of the negative electrode and a portion of one end side of the separator between a first winding shaft and a second winding shaft, and a step (ii) of forming the wound body by rotating the first winding shaft and the second winding shaft while the portion of the negative electrode and the portion of the separator are sandwiched between the first winding shaft and the second winding shaft, thereby to wind the positive electrode, the negative electrode, and the separator, the steps (i) and (ii) being performed in this order, and in the step (ii), the positive electrode, the negative electrode, and the separator are wound such that both surfaces of the positive electrode face the negative electrode.

An aspect of the disclosure relates to a first electrochemical device. The first electrochemical device includes a wound body that is constituted of a belt-shaped positive electrode containing active carbon as a positive electrode active material, a belt-shaped negative electrode, and a belt-shaped separator interposed between the positive electrode and the negative electrode, wherein the wound body includes a winding shaft part that is formed by being sandwiched between winding shafts and a winding part that is connected to the winding shaft part, the winding shaft part includes a portion of one end side of the negative electrode and a portion of one end side of the separator, and the positive electrode, the negative electrode, and the separator are wound in the wound body such that both surfaces of the positive electrode face the negative electrode.

An aspect of the disclosure relates to a second manufacturing method for an electrochemical device. The second manufacturing method is a manufacturing method of an electrochemical device that includes a wound body constituted of a belt-shaped positive electrode containing active carbon as a positive electrode material, a belt-shaped negative electrode, and a belt-shaped separator interposed between the positive electrode and the negative electrode,
wherein the separator includes a belt-shaped first separator and a belt-shaped second separator,
the manufacturing method includes in an order listed:
a step (I) of sandwiching only a portion of one end side of the first separator and a portion of one end side of the second separator between winding shafts; and
a step (II) of forming the wound body by rotating the winding shafts while maintaining the state of the step (I) to wind the positive electrode, the negative electrode, and the first and second separators,
the winding shafts are constituted of first and second winding shafts each having a semicircular cross section with a diameter of length A,
the first separator has an average thickness T1,
the second separator has an average thickness T2, and
in the step (II), the winding is performed such that:
(a) a distance B between one end of the negative electrode close to the winding shafts and the winding shafts and the length A satisfy πA<B; and
(b) a distance C between one end of the positive electrode close to the winding shafts and the one end of the negative electrode, the length A, the average thickness T1, and the average thickness T2 satisfy π(A+(T1+T2)×2n)<C (where n is the number of turns by which only the first and second separators are wound).

An aspect of the disclosure relates to a second electrochemical device. The second electrochemical device is an electrochemical device including a wound body that is constituted of a belt-shaped positive electrode containing active carbon as a positive electrode active material, a belt-shaped negative electrode, and a belt-shaped separator interposed between the positive electrode and the negative electrode,
wherein the separator includes a belt-shaped first separator and a belt-shaped second separator,
the wound body includes a winding shaft part that is formed by being sandwiched between winding shafts and a winding part that is connected to the winding shaft part,
the winding shaft part is constituted only of the first and second separators,
the winding shaft part includes a first end that is a boundary with the winding part and a second end that is opposite to the first end,
the winding part includes a reinforcement part in which only the first and second separators are wound one or more turns between the first end and one end of the negative electrode close to the winding shaft part, and
in the wound body, a surface of the positive electrode close to the winding shaft part faces the negative electrode.

An aspect of the disclosure relates to a third electrochemical device. The third electrochemical device includes a wound body that is constituted of a belt-shaped first electrode, a belt-shaped second electrode, and a belt-shaped separator interposed at least between the first electrode and the second electrode, wherein an outermost periphery of the second electrode is arranged outside an outermost periphery of the first electrode, and a portion of the second electrode near an outer peripheral end is bent so that the outer peripheral end of the second electrode is in abutment with the separator.

### Advantageous Effects of Invention

According to an aspect of the present disclosure, it is possible to obtain a high-reliability wound-type electrochemical device that can be manufactured with good yield.

According to another aspect of the present disclosure, it is possible to obtain an electrochemical device in which the wound body is unlikely to unwind.

### BRIEF DESCRIPTION OF DRAWINGS

FIG. 1A A cross-sectional diagram schematically showing a step of a manufacturing method according to a first embodiment.

FIG. 1B A top view of FIG. 1A.

FIG. 2 A cross-sectional diagram schematically showing an example of a wound body manufactured by the manufacturing method according to the first embodiment.

FIG. 3 A partially exploded perspective diagram schematically showing an electrochemical device according to the first embodiment.

FIG. 4A A cross-sectional diagram schematically showing a step of a manufacturing method according to a second embodiment.

FIG. 4B A top view of FIG. 4A.

FIG. 5 A cross-sectional diagram schematically showing an example of a wound body manufactured by the manufacturing method according to the second embodiment.

FIG. 6 A partially exploded perspective diagram schematically showing an electrochemical device according to the second embodiment.

FIG. 7 A partial cross-sectional diagram schematically showing an example of a wound body used in an electrochemical device according to a third embodiment.

FIG. 8 A diagram schematically showing a step of an example of a manufacturing method of the wound body.

FIG. 9 A partially exploded perspective diagram schematically showing an example of the electrochemical device according to the third embodiment.

### DESCRIPTION OF EMBODIMENTS

Hereinafter, embodiments according to the present disclosure will be described taking examples, but the present disclosure is not limited to the examples described below. In the following description, specific numerical values and materials will be exemplified, but other numerical values and other materials may be applied as long as the invention according to the present disclosure can be implemented. The description “numerical value A to numerical value B” herein includes numerical value A and numerical value B, and can be read as “numerical value A or more and numerical value B or less”. In the following description, when lower limits and upper limits of numerical values related to specific physical properties or conditions are exemplified, any of the exemplified lower limits and any of the exemplified upper limits can be combined as desired, as long as the lower limit is not equal to or greater than the upper limit.

Electrochemical devices (D1), (D2), and (D3) will be described below. As long as no technical contradiction occurs, the configurations of the electrochemical devices (D1), (D2), and (D3) may be at least partially combined.

### (First Manufacturing Method of Electrochemical Device)

A first manufacturing method according to the present embodiment is a manufacturing method of an electrochemical device that includes a wound body constituted of a belt-shaped positive electrode containing active carbon as a positive electrode material, a belt-shaped negative electrode, and a belt-shaped separator interposed between the positive electrode and the negative electrode. Hereinafter, the first manufacturing method will also be called “manufacturing method (M1)”. The manufacturing method (M1) includes a step (i) and a step (ii) in this order. These steps will be described below.

The step (i) is a step of sandwiching a portion of one end side of the negative electrode and a portion of one end side of the separator between a first winding shaft and a second winding shaft. There is no limitation on the first winding shaft and the second winding shaft, and they may be any members that serve as winding shafts in forming a wound body. For example, each of the first winding shaft and the second winding shaft may be a rod-shaped body having a semicircular cross section.

The separator may include a first separator and a second separator. In that case, the step (i) may be a step of sandwiching a portion of one end side of the negative electrode, a portion of one end side of the first separator, and a portion of one end side of the second separator between the first winding shaft and the second winding shaft. In that case, the negative electrode may be sandwiched between the first separator and the second separator. Alternatively, the step (i) may be a step of sandwiching a portion of one end side of the negative electrode and a portion of one end side of the first separator between the first winding shaft and the second winding shaft. A belt-shaped separator may be folded in two, and the two folds of the separator may be used as the first and second separators.

The step (ii) is a step of rotating the first winding shaft and the second winding shaft while sandwiching a portion of the negative electrode and a portion of the separator between the first winding shaft and the second winding shaft to wind the positive electrode, the negative electrode, and the separator, thereby to form the wound body. In the step (ii), the positive electrode, the negative electrode, and the separator are wound such that both surfaces of the positive electrode face the negative electrode.

The winding in the step (ii) is performed while the state of the step (i) (that is, the state in which a portion of the negative electrode and a portion of the separator are sandwiched between the first winding shaft and the second winding shaft) is maintained. At the time of winding, the positive electrode, the negative electrode, and the separator are wound to form a wound body constituted of them.

To wind the positive electrode, the negative electrode, and the separator such that both surfaces of the positive electrode face the negative electrode, the winding may be performed as described below, for example. At the position close to the winding shafts, first, the positive electrode is not wound but only the negative electrode and the separator are wound, and then the positive electrode, the negative electrode, and the separator are wound together. Next, at the outer peripheral part of the wound body, they are wound such that the negative electrode is arranged outside the positive electrode. This makes it possible to form a wound body such that both surfaces of the positive electrode face the negative electrode.

In the manufacturing method (M1), the negative electrode and the separator are wound together at the winding shafts, which prevents winding misalignment of the negative electrode. Therefore, the manufacturing method (M1) makes it is possible to manufacture a high-reliability wound-type electrochemical device with good yield.

In the manufacturing method (M1), a wound body is formed such that both surfaces of the positive electrode face the negative electrode. With this configuration, the deterioration of the separator may be suppressed. If the positive electrode has a part (non-facing part) that does not face the negative electrode, hydrogen ions (H) generated at the positive electrode are unlikely to diffuse, and a localized acidic atmosphere may be formed at this part. In the acidic atmosphere, a dehydration reaction of the separator will occur to generate water in the cell, thereby causing rapid deterioration of the cell. The manufacturing method (M1) makes it possible to manufacture a wound body without a non-facing part of the positive electrode, so that these problems can be suppressed.

In the manufacturing method (M1), in the step (i), a portion of the one end side of the negative electrode and a portion of the one end side of the separator may be sandwiched between the first winding shaft and the second winding shaft such that the one end of the negative electrode protrudes from between the first winding shaft and the second winding shaft. With this configuration, the negative electrode is bent twice at the winding shafts, so that winding misalignment can be particularly suppressed. In this case, a portion of the one end side of the negative electrode and a portion of the one end side of the separator may be sandwiched between the first winding shaft and the second winding shaft such that the one end of the negative electrode and one end of the separator protrude from between the first winding shaft and the second winding shaft.

In the manufacturing method (M1), in the step (i), the positive electrode may not be sandwiched between the first winding shaft and the second winding shaft. With this configuration, both surfaces of the positive electrode can completely face the negative electrode.

A wound body can be formed by the above steps. The obtained wound body is enclosed in an exterior body together with an electrolyte as necessary. If necessary, a lead is connected to the positive electrode and/or the negative electrode before or after the formation of the wound body. In this manner, an electrochemical device is obtained. The electrochemical device can be used as a power storage device.

### (Electrochemical Device)

A first electrochemical device according to the present embodiment includes a wound body that is constituted of a belt-shaped positive electrode containing active carbon as a positive electrode active material, a belt-shaped negative electrode, and a belt-shaped separator interposed between the positive electrode and the negative electrode. Hereinafter, the first electrochemical device will also be called “electrochemical device (D1)”. The electrochemical device (D1) can be manufactured by the manufacturing method (M1), but may also be manufactured by a manufacturing method other than the manufacturing method (M1). The matters described for the manufacturing method (M1) can be applied to the electrochemical device (D1), so that duplicated descriptions may be omitted. In addition, the matters described for the electrochemical device (D1) may be applied to the manufacturing method (M1).

In the electrochemical device (D1), the wound body includes a winding shaft part that is formed by being sandwiched between winding shafts (for example, between two winding shafts) and a winding part that is connected to the winding shaft part. The winding shaft part includes a portion of one end side of the negative electrode and a portion of one end side of the separator. In the wound body, the positive electrode, the negative electrode, and the separator are wound such that both surfaces of the positive electrode face the negative electrode.

When the winding shafts includes a first winding shaft and a second winding shaft, the winding shaft part is a part that is sandwiched between the first winding shaft and the second winding shaft at the manufacture of the wound body. In an example, the winding shaft part is arranged so as to divide a cylindrical space present in the center of the wound body into two semi-cylindrical spaces.

In the electrochemical device (D1), the negative electrode and the separator are bent at the boundary between the winding shaft part and the winding part. Accordingly, in the electrochemical device (D1), it is possible to suppress the occurrence of winding misalignment and the loosening of the wound body. Therefore, the electrochemical device (D1) with high reliability can be manufactured with good yield.

In the electrochemical device (D1), the wound body may further include a protrusion that is connected to the winding shaft part on the side opposite to the winding part. The protrusion may include the one end of the negative electrode. Alternatively, the protrusion may include the one end of the negative electrode and the one end of the separator. According to these configurations, the negative electrode is bent twice before and after the protrusion, which particularly prevents loosening of the wound body.

In the electrochemical device (D1), the winding shaft part may not include the positive electrode. With this configuration, both surfaces of the positive electrode can completely face the negative electrode.

Examples of the configuration and components of the electrochemical device (D1) will be described below. Known components may be applied to components other than the components characteristic of the present disclosure.

The electrochemical device (D1) includes a wound body and is cylindrical in shape, for example. The electrochemical device (D1) may be an electrical double layer capacitor (EDLC) or another power storage device (for example, a lithium ion capacitor). If the electrochemical device (D1) is an electrical double layer capacitor, polarizable electrodes can be used as the positive electrode and negative electrode. The polarizable electrodes include an electrode material (active material) that is capable of adsorbing and desorbing ions. The electrode material adsorbs and desorbs ions to perform charging and discharging. If the electrochemical device (D1) is a lithium ion capacitor, a polarizable electrode can be used as the positive electrode, and a non-polarizable electrode can be used as the negative electrode. The negative electrode, which is a non-polarizable electrode, may be a negative electrode used in a lithium ion secondary battery. Examples of such a negative electrode include a negative electrode active material (for example, graphite) that is capable of occluding and releasing lithium ions.

### (Second Manufacturing Method of Electrochemical Device)

A second manufacturing method according to the present embodiment is a manufacturing method of an electrochemical device that includes a wound body constituted of a belt-shaped positive electrode containing active carbon as a positive electrode material, a belt-shaped negative electrode, and a belt-shaped separator interposed between the positive electrode and the negative electrode. Hereinafter, the second manufacturing method will also be called “manufacturing method (M2)”. The separator includes a belt-shaped first separator and a belt-shaped second separator. The manufacturing method (M2) includes a step (I) and a step (II) in this order. These steps will be described below.

The step (I) is a step of sandwiching only a portion of the one end side of the first separator and a portion of the one end side of the second separator between the winding shafts. The winding shafts are constituted of first and second winding shafts. Each of the first and second winding shafts has a semicircular cross section (for example, a cross section of half a perfect circle) with a diameter of length A (mm).

The step (II) is a step of forming the above-described wound body by rotating the winding shafts while maintaining the state of step (I) to wind the positive electrode, the negative electrode, and the first and second separators.

The belt-shaped first separator has an average thickness T1 (mm). The belt-shaped second separator has an average thickness T2 (mm). The belt-shaped separator may be folded into two, and the two folds of the separator may be used as the first and second separators.

In an example of the manufacturing method (M2), in the step (II), the winding is performed so as to satisfy the following conditions (a) and (b):
(a) a distance B (mm) between one end of the negative electrode close to the winding shafts and the winding shafts and the length A satisfy πA<B; and
(b) a distance C (mm) between one end of the positive electrode close to the winding shafts and the one end of the negative electrode, the length A, the average thickness T1, and the average thickness T2 satisfy π(A+(T1+T2)×2n)<C (where n is the number of turns by which only the first and second separators are wound). More specifically, n is the number of turns by which only the first and second separators are wound on the winding shafts side, and is the number of turns of the first and second separators in the part to be the reinforcement part.

In another example of the manufacturing method (M2), in the step (II), the winding is performed so as to satisfy the following conditions (a′) and (b′):
(a′) only the first and second separators are wound one or more turns, and then winding of the negative electrode is started; and
(b′) the surface of the positive electrode close to the winding shaft part faces the negative electrode.

When the condition (a) or (a′) is satisfied, the negative electrode does not contact the winding shafts, and therefore it is possible to suppress damage of the negative electrode. This makes it possible to manufacture a high-reliability electrochemical device with good yield.

Satisfying the condition (b) or (b′) prevents the positive electrode from having a part (non-opposing part) that does not face the negative electrode on the winding shaft part side. This configuration may suppress the deterioration of the separator. If the positive electrode has a non-opposing part that does not face the negative electrode, negative ions are adsorbed and concentrated near the positive electrode at the non-opposing part during charging, while positive ions are concentrated on the separator because there is no negative electrode to which positive ions are to be adsorbed at the non-opposing part, thereby resulting in an imbalance of ions. This may carbonize the separator. The manufacturing method (M2) makes it possible to manufacture a wound body without a non-opposing part of the positive electrode, so that these problems can be suppressed.

In an example of the step (II), first, a stacked structure of “first separator/second separator” is wound, then a stacked structure of “first separator/negative electrode/second separator” is wound, and then a stacked structure of “first separator/negative electrode/second separator/positive electrode” is wound.

In the step (II), the winding may be performed so as to satisfy the following condition (c) or (c′):
(c) the distance B and the length A satisfy 2πA<B; or
(c′) only the first and second separators are wound two or more turns, and then winding of the negative electrode is started.

Satisfying the condition (c) or (c′) reinforces the part of the wound body where only the separator is wound (the part close to the center of the wound body). Therefore, when the winding shafts are removed after completion of the winding, the occurrence of a short circuit due to breakage of the separator can be suppressed. The distance B and the length A may satisfy B≤3πA. That is, the number of turns by which only the first and second separators are wound may be three or less.

In step (II), the wound body may be formed such that both surfaces of the positive electrode face the negative electrode. This configuration particularly suppresses the deterioration of the separator. As described above, satisfying the condition (b) or (b′) allows both surfaces of the positive electrode close to the winding shafts to face the negative electrode. At the outer peripheral portion of the wound body, the positive electrode and the negative electrode are wound such that the negative electrode is arranged outside the positive electrode. In this manner, the wound body can be formed such that both surfaces of the positive electrode face the negative electrode.

In the step (I), only the portions of the first and second separators may be sandwiched between the first and second winding shafts such that the ends of the first and second separators protrude from between the winding shafts. With this configuration, the separators are bent twice before and after the winding shafts, and thus winding misalignment of the separators can be suppressed. Therefore, it is possible to manufacture a higher-reliability electrochemical device with higher yield.

A wound body can be formed by the above steps. The obtained wound body is enclosed in an exterior body together with an electrolyte as necessary. If necessary, a lead is connected to the positive electrode and/or the negative electrode before or after the formation of the wound body. In this manner, an electrochemical device is obtained. The electrochemical device can be used as a power storage device.

### (Electrochemical Device)

A second electrochemical device according to the present embodiment includes a wound body that is constituted of a belt-shaped positive electrode containing active carbon as a positive electrode active material, a belt-shaped negative electrode, and a belt-shaped separator interposed between the positive electrode and the negative electrode. Hereinafter, the second electrochemical device will also be called “electrochemical device (D2)”. The electrochemical device (D2) can be manufactured by the manufacturing method (M2). The matters described for the manufacturing method (M2) can be applied to the electrochemical device (D2), so that duplicated descriptions may be omitted. In addition, the matters described for the electrochemical device (D2) may be applied to the manufacturing method (M2).

The separator includes a belt-shaped first separator and a belt-shaped second separator. The wound body includes a winding shaft part that is formed by being sandwiched between winding shafts, and a winding part that is connected to the winding shaft part. The winding shaft part is constituted of only the first and second separators. The winding shaft part includes a first end that is a boundary with the winding part, and a second end opposite to the first end. The winding part includes a reinforcement part in which only the first and second separators are wound one or more turns between the first end and one end of the negative electrode close to the winding shaft part. In the wound body, the surface of the positive electrode close to the winding shaft part faces the negative electrode.

The winding shaft part is formed by being sandwiched between the first winding shaft and the second winding shaft. In an example, the winding shaft part is arranged so as to divide a cylindrical space in the center of the wound body into two semi-cylindrical spaces.

According to the electrochemical device (D2), it is possible to obtain the advantageous effects that would be obtained by satisfying the above-described conditions (a) (or (a′)) and (b) (or (b′)). Therefore, the electrochemical device (D2) with high reliability can be manufactured with good yield.

At the reinforcement part of the electrochemical device (D2), only the first and second separators may be wound two or more turns.

In the electrochemical device (D2), both surfaces of the positive electrode may face the negative electrode.

The wound body of the electrochemical device (D2) may include a protrusion that is constituted of only the first and second separators and protrudes from the second end.

Examples of the configuration and components of the electrochemical device (D2) will be described below. Known components may be applied to components other than the components characteristic of the present disclosure.

The electrochemical device (D2) includes a wound body and is cylindrical in shape, for example. The electrochemical device (D2) may be an electrical double layer capacitor (EDLC) or another power storage device (for example, a lithium ion capacitor). If the electrochemical device (D2) is an electrical double layer capacitor, polarizable electrodes can be used as the positive electrode and negative electrode. The polarizable electrodes include an electrode material (active material) that is capable of adsorbing and desorbing ions. The electrode material adsorbs and desorbs ions to perform charging and discharging. If the electrochemical device (D2) is a lithium ion capacitor, a polarizable electrode can be used as the positive electrode, and a non-polarizable electrode can be used as the negative electrode. The negative electrode, which is a non-polarizable electrode, may be a negative electrode used in a lithium ion secondary battery. Examples of such a negative electrode include a negative electrode active material (for example, graphite) that is capable of occluding and releasing lithium ions.

### (Third Electrochemical Device)

Hereinafter, a third electrochemical device according to the present embodiment will also be called “electrochemical device (D3)”. The electrochemical device (D3) according to the present embodiment includes a wound body that is constituted of a belt-shaped first electrode, a belt-shaped second electrode, and a belt-shaped separator disposed at least between the first electrode and the second electrode. The outermost periphery of the second electrode is arranged outside the outermost periphery of the first electrode. A portion of the second electrode near the outer peripheral end is bent so that the outer peripheral end of the second electrode is in abutment with the separator. Hereinafter, the outer peripheral end of the second electrode will also be called “outer peripheral end (E2)”.

With the above configuration, the outer peripheral end (E2) is in abutment with the surface of the separator. This suppresses misalignment of the outer peripheral end (E2) and the separator, and suppresses unwinding of the wound body. This configuration can be achieved by bending the portion of the second electrode near the outer peripheral end (E2). Therefore, the process can be simply carried out at low cost as compared to a method of fixing the outer periphery of the wound body using tape.

There is no particular limitation on the polarities of the first and second electrodes. For example, the first electrode may be a positive electrode and the second electrode may be a negative electrode, or the first electrode may be a negative electrode and the second electrode may be a positive electrode. Alternatively, the first electrode may be an anode and the second electrode may be a cathode, or the first electrode may be a cathode and the second electrode may be an anode. Alternatively, the polarities of the first and second electrodes may not be specified. As described later, the separator usually includes a first separator and a second separator.

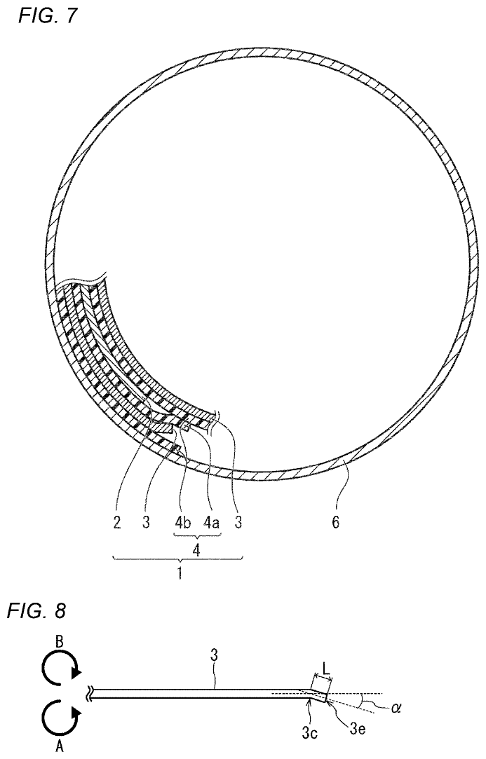

First and second examples of the bending of the outer peripheral end (E2) will be described below. In the first example, a portion of the second electrode near the outer peripheral end (E2) is bent toward the inside of the wound body, and the outer peripheral end (E2) is in abutment with the separator that is present inside the outer peripheral end (E2). Since a portion near the outer peripheral end (E2) is bent toward the inside, the separator can be pressed down by the surface of the bent portion in abutment with the separator, so that it is possible to suppress the variation in the inter-electrode distance (the distance between a first electrode 2 and a second electrode 3 in FIG. 7) due to the expansion and contraction of the electrode foil during charging and discharging, and to suppress the variation in the resistance value that is a characteristic of the device, thereby to stabilize the resistance value.

In the first example, preferably, two separators (first and second separators) are stacked inside the outer peripheral end (E2). From another viewpoint, preferably, the outer peripheral end (E2) faces the second electrode inside with the separator therebetween. This configuration makes it possible to suppress the outer peripheral end (E2) from damaging the separators and causing a short circuit between the first electrode and the second electrode.

The second example can be employed when the separator is present outside the outer peripheral end (E2) of the second electrode. In the second example, a portion of the second electrode near the outer peripheral end (E2) is bent toward the outside of the wound body, and the outer peripheral end (E2) is in abutment with the separator present outside the outer peripheral end (E2). The above-described advantageous effect (the stabilization of the resistance value) can be obtained by bending a portion near the outer peripheral end (E2) toward the outside. Furthermore, when a portion near the outer peripheral end (E2) is bent toward the outside, the outer peripheral end (E2) does not come into contact with the first electrode even if the outer peripheral end (E2) breaks through the separator. Therefore, the occurrence of a short circuit between the first electrode and the second electrode can be further suppressed.

In general, the first electrode includes a first current collector and a first mixture layer formed on both surfaces of the first current collector, and the second electrode includes a second current collector and a second mixture layer formed on both surfaces of the second current collector. In the electrochemical device (D3), the second current collector may be exposed at the end face of the outer peripheral end in a state of being sandwiched between the second mixture layers. Exposing the second current collector at the end face makes the second current collector and the separator less likely to be misaligned. In addition, sandwiching the second current collector between the mixture layers appropriately protects the edge of the second current collector, whereby the separator can be prevented from being damaged by the edge of the second current collector.

The position of the portion of the second electrode that is bent (the bent portion) may be separated 0.01 mm or more, 0.1 mm or more, or 0.2 mm or more from the outer peripheral end (E2) of the second electrode. The position of the bent portion may be in a range of 0.5 mm or less, or 0.3 mm or less from the outer peripheral end (E2) of the second electrode. For example, the portion of the second electrode that is bent (the bent portion) may be present in a range of 0.01 mm to 0.5 mm (for example, in a range of 0.1 mm to 0.5 mm) from the outer peripheral end (E2) of the second electrode. This configuration particularly enhances the advantageous effect of preventing the unwinding of the wound body. These distances are measured along the longitudinal direction of the electrode.

The angle α (see FIG. 8) at which the second electrode is bent at the bent portion is 900 or less. The angle α may be 5° or more, 150 or more, or 300 or more. The angle α may be 900 or less, 600 or less, 450 or less, or 300 or less. The angle α may be in a range of 15 to 60°, in a range of 30 to 60°, or in a range of 15 to 45°.

In the electrochemical device (D3), a portion of the first electrode near the outer peripheral end (hereinafter, also called “outer peripheral end (E1)”) may be bent and the outer peripheral end (E1) of the first electrode may be in abutment with the separator. This configuration suppresses misalignment of the first electrode and the separator. Therefore, it is possible to particularly suppress the unwinding of the wound body.

The outer peripheral edge (E1) of the first electrode may be bent inward or outward. The bending direction of the outer peripheral edge (E1) of the first electrode may be the same as or different from the bending direction (inward or outward) of the outer peripheral edge (E2) of the second electrode.

Examples of a configuration and components of the electrochemical device (D3) will be described below. Known components may be applied to components other than components characteristic of the present disclosure.

The electrochemical device (D3) includes a wound body, and is cylindrical in shape, for example. The electrochemical device (D3) may be an electrical double layer capacitor (EDLC) or another power storage device (for example, a lithium ion capacitor). Alternatively, the electrochemical device may be another capacitor or battery. For the first and second electrodes of the electrochemical device (D3), electrodes appropriate for the device may be used, and known electrodes appropriate for the device may be used.

If the electrochemical device (D3) is an electrical double layer capacitor, polarizable electrodes can be used as the positive electrode and negative electrode. The polarizable electrodes include an electrode material (active material) that is capable of adsorbing and desorbing ions. The electrode material adsorbs and desorbs ions to perform charging and discharging. If the electrochemical device (D3) is a lithium ion capacitor, a polarizable electrode can be used as the positive electrode, and a non-polarizable electrode can be used as the negative electrode. The negative electrode, which is a non-polarizable electrode, may be a negative electrode used in a lithium ion secondary battery. Examples of such a negative electrode include a negative electrode active material (for example, graphite) that is capable of occluding and releasing lithium ions.

Hereinafter, examples of components of the electrochemical devices (D1) and (D2) that are electrical double layer capacitors will be mainly described. If the electrochemical devices (D1) and (D2) are electrochemical devices other than electrical double layer capacitors, the electrodes, separators, and electrolytes may be selected according to the type of the electrochemical devices.

### (Positive Electrode)

The positive electrode (positive electrode plate) includes a belt-shaped positive electrode current collector and a positive electrode mixture layer that is arranged on both surfaces of the positive electrode current collector. The positive electrode mixture layer contains active carbon as a positive electrode material (active material).

The positive electrode mixture layer contains active carbon that is a positive electrode active material, as an essential component. The positive electrode material may contain a carbon material other than active carbon. Examples of such a carbon material include carbon nanotubes, graphite, graphene, and the like. Examples of raw materials for active carbon include wood, coconut shells, pulp waste liquid, coal or coal-based pitch obtained by thermal decomposition of coal, heavy oil or petroleum-based pitch obtained by thermal decomposition of heavy oil, phenol resin, petroleum coke, coal coke, and the like. The active carbon preferably has undergone activation treatment.

The positive electrode mixture layer may contain components other than the positive electrode material (active material). Examples of the other components include a binder, a conductive material, and the like. The binder may be a resin material such as polytetrafluoroethylene (PTFE), carboxymethyl cellulose (CMC), styrene-butadiene rubber (SBR), or the like, for example. The conductive material may be carbon black (for example, acetylene black), or the like.

The positive electrode current collector may be a belt-shaped metal foil (for example, aluminum foil). The thickness of the positive electrode current collector is not particularly limited. The thickness of the positive electrode current collector of the electrochemical device (D1) may be in a range of 10 μm to 50 μm (for example, in a range of 15 μm to 30 μm). The thickness of the positive electrode current collector of the electrochemical device (D2) may be in a range of 10 μm to 50 μm (for example, in a range of 20 μm to 30 μm). The surface of the positive electrode current collector may be roughened by a method such as etching (the same applies to the negative electrode current collector).

### (Negative Electrode)

The negative electrode (negative electrode plate) includes a belt-shaped negative electrode current collector and a negative electrode mixture layer that is arranged on both surfaces of the negative electrode current collector. The negative electrode mixture layer includes a negative electrode material (active material). The negative electrode material includes a negative electrode material (active material) that is capable of adsorbing and desorbing ions. Examples of the negative electrode material include carbon materials, and the negative electrode material may be any of the carbon materials exemplified above as the positive electrode active materials. Specifically, the negative electrode material may be active carbon, hard carbon, carbon nanotubes, graphite, graphene, or the like.

The negative electrode mixture layer may contain components other than the negative electrode material (active material). Examples of the other components include a binder and a conductive material. The binder and the conductive material may be any of the substances exemplified above as the binder and conductive material of the positive electrode.

The negative electrode current collector may be a belt-shaped metal foil (for example, aluminum foil). The thickness of the negative electrode current collector is not particularly limited. The thickness of the negative electrode current collector of the electrochemical device (D1) may be in a range of 5 μm to 50 μm (for example, in a range of 5 μm to 20 μm). The thickness of the negative electrode current collector of the electrochemical device (D2) may be in a range of 10 μm to 50 μm (for example, in a range of 20 μm to 30 μm).

The method for forming the above electrodes (positive and negative electrodes) is not limited, and the electrodes may be formed by a known method. For example, the mixture layer may be formed by the method described below. First, a slurry is prepared by mixing an electrode material (active material), a binder and/or a conductive material, and a dispersion medium. Then, the obtained slurry is applied to the surface of a current collector to form a coating film. Then, the coating film is dried and rolled to form a mixture layer on the surfaces of the current collector. In this manner, the mixture layer is formed.

### (Separator)

The separator is interposed between the positive electrode and the negative electrode to prevent a short circuit between the positive electrode and the negative electrode. Examples of the material of the separator include an insulating resin, glass, and the like. Examples of the separator include nonwoven fabric mainly constituted of cellulose, glass fiber mat, microporous film of polyolefin such as polyethylene, and the like. The separator may be a known separator used in electrical double layer capacitors or lithium ion capacitors.

The thickness of the separator of the electrochemical device (D1) is not particularly limited, and may be in a range of 15 μm to 60 μm (for example, in a range of 20 μm to 40 μm).

The average thicknesses T1 and T2 of the separators of the electrochemical device (D2) are not particularly limited, and may each be in a range of 10 μm to 50 μm (for example, in a range of 15 μm to 40 μm).

The average thickness of the separator is measured by the procedure described below. First, a test piece with a length of about 500 mm is folded in two and the thickness is measured at five equally spaced points. The average thickness is calculated by dividing the arithmetic average of the thicknesses measured at the five points by the number of folds. Usually, the same type of separator is used for the first separator and the second separator. In this case, the average thickness T1 of the first separator may be taken as the average thickness T2 of the second separator.

### (Electrolyte (Electrolytic Solution))

The electrolyte may be an electrolyte containing a solvent and an ionic substance. Examples of the electrolyte include a non-aqueous electrolyte containing a non-aqueous solvent and an ionic substance. The ionic substance is dissolved in the solvent and contains a cation and an anion. The ionic substance may contain a low-melting point compound (ionic liquid) that can exist as a liquid at and around room temperature. The concentration of the ionic substance in the electrolyte is 0.5 mol/L or more and 2.0 mol/L, for example.

The solvent may contain a lactone compound. Examples of the lactone compound include β-propiolactone, γ-butyrolactone, γ-valerolactone, δ-valerolactone, and the like. The lactone compound preferably contains γ-butyrolactone (GBL) in that it has a small viscosity even at low temperatures, is electrochemically stable in the voltage range of the device, and emits a small amount of gas.

The solvent may contain a solvent other than the lactone compound. Examples of the other solvent include chain carboxylic acid esters such as methyl propionate, chain carbonic acid esters such as diethyl carbonate, cyclic carbonic acid esters such as propylene carbonate, polyhydric alcohols such as ethylene glycol and propylene glycol, cyclic sulfones such as sulfolane, amides such as N-methylacetamide, N,N-dimethylformamide, and N-methyl-2-pyrrolidone, ethers such as 1,4-dioxane, ketones such as methyl ethyl ketone, formaldehyde, and the like. The solvent may contain acetonitrile.

When the solvent is a mixed solvent of a lactone compound and another solvent, the proportion of the lactone compound in the solvent may be 50% by volume or more and 85% by volume or less.

The ionic substance includes an organic salt, for example. An organic salt is a salt in which at least one of the anion and cation contains an organic substance. An example of the organic salt in which the cation contains an organic substance is a quaternary ammonium salt. Examples of the organic salt in which the anion (or both ions) contains an organic substance include trimethylamine maleate, triethylamine borodisalicylate, ethyldimethylamine phthalate, mono 1,2,3,4-tetramethylimidazolinium phthalate, mono 1,3-dimethyl-2-ethylimidazolinium phthalate, and the like.

From the viewpoint of improving the withstand voltage characteristics, the anion preferably contains an anion of a fluorine-containing acid. Examples of the anion of a fluorine-containing acid include BF₄⁻ and/or PF₆⁻. The organic salt preferably contains a cation of tetraalkylammonium and an anion of fluorine-containing acid, for example. Specific examples include diethyldimethylammonium tetrafluoroborate (DEDMABF₄), triethylmethylammonium tetrafluoroborate (TEMABF₄), and the like.

If the electrochemical device is a lithium ion capacitor (LIC), the ionic substance includes a lithium salt. The lithium salt is preferably a salt having a fluorine-containing anion. Among the salts having a fluorine-containing anion, at least one selected from the group consisting of LiBF₄, LiPF₆, and lithium bis(fluorosulfonyl)imide (LiN(SO₂F)₂) is more preferable. LiN(SO₂F)₂ is also called LiFSI or LFSI. Among the salts having a fluorine-containing anion, LFSI is less likely to produce by-products and has excellent stability.

Hereinafter, examples of components of the electrochemical device (D3) that is an electrical double layer capacitor in which the first electrode is a positive electrode and the second electrode is a negative electrode will be mainly described. If the electrochemical device (D3) is an electrochemical device other than an electrical double layer capacitor, the electrodes, separator, and electrolyte may be selected according to the type of the electrochemical device.

### (Positive Electrode)

The positive electrode (positive electrode plate) includes a belt-shaped positive electrode current collector (first current collector) and a positive electrode mixture layer (first mixture layer) that is arranged on both surfaces of the positive electrode current collector. The positive electrode mixture layer contains active carbon as a positive electrode material (active material).

The positive electrode material may contain a carbon material other than active carbon. Examples of such a carbon material include carbon nanotubes, graphite, graphene, and the like. Examples of raw materials for active carbon include wood, coconut shells, pulp waste liquid, coal or coal-based pitch obtained by thermal decomposition of coal, heavy oil or petroleum-based pitch obtained by thermal decomposition of heavy oil, phenol resin, petroleum coke, coal coke, and the like. The active carbon preferably has undergone activation treatment.

The positive electrode mixture layer may contain components other than the positive electrode material (active material). Examples of the other components include a binder, a conductive material, and the like. The binder may be a resin material such as polytetrafluoroethylene (PTFE), carboxymethyl cellulose (CMC), styrene-butadiene rubber (SBR), or the like, for example. The conductive material may be carbon black (for example, acetylene black), or the like.

The positive electrode current collector may be a belt-shaped metal foil (for example, aluminum foil). The thickness of the current collector is not particularly limited, and may be in a range of 10 μm to 100 μm (for example, in a range of 15 μm to 40 μm). The surface of the positive electrode current collector may be roughened by a method such as etching (the same applies to the negative electrode current collector).

### (Negative Electrode)

The negative electrode (negative electrode plate) includes a belt-shaped negative electrode current collector (second current collector) and a negative electrode mixture layer (second mixture layer) that is arranged on both surfaces of the negative electrode current collector. The negative electrode mixture layer includes a negative electrode material (active material). The negative electrode material includes a negative electrode material (active material) that is capable of adsorbing and desorbing ions. Examples of the negative electrode material include carbon materials, and the negative electrode material may be any of the carbon materials exemplified above as the positive electrode active materials. Specifically, the negative electrode material may be active carbon, hard carbon, carbon nanotubes, graphite, graphene, or the like.

The negative electrode mixture layer may contain components other than the negative electrode material (active material). Examples of the other components include a binder and a conductive material. The binder and the conductive material may be any of the substances exemplified above as the binder and conductive material of the positive electrode.

The negative electrode current collector may be a belt-shaped metal foil (for example, aluminum foil). The thickness of the current collector is not particularly limited, and may be in a range of 10 μm to 100 μm (for example, in a range of 15 μm to 40 μm).

The method for forming the first and second electrodes (positive electrode and negative electrode) is not limited, and the electrodes may be formed by a known method. For example, the mixture layer may be formed by the method described below. First, a slurry is prepared by mixing an electrode material (active material), a binder and/or a conductive material, and a dispersion medium. Then, the obtained slurry is applied to the surface of a current collector to form a coating film. Then, the coating film is dried and rolled to form a mixture layer on the surfaces of the current collector. In this manner, the mixture layer is formed.

### (Separator)

The separator is interposed between the first electrode and the second electrode (positive electrode and the negative electrode) to prevent a short circuit between the positive electrode and the negative electrode. Examples of the material of the separator include an insulating resin, glass, and the like. Examples of the separator include nonwoven fabric mainly constituted of cellulose, glass fiber mat, microporous film of polyolefin such as polyethylene, and the like. The separator may be a known separator used in electrical double layer capacitors or lithium ion capacitors.

Usually, the separator includes a belt-shaped first separator and a belt-shaped second separator. The belt-shaped separator may be folded into two, and the two folds of the separator may be used as the first and second separators.

The average thickness of the separator is not particularly limited, and may be in a range of 10 μm to 100 μm (for example, in a range of 20 μm to 40 μm).

### (Electrolyte)

The electrolyte (electrolytic solution) may be an electrolyte used in an electrical double layer capacitor. For example, the electrolyte may be a non-aqueous solvent in which a solute (such as an organic salt or an inorganic salt) is dissolved.

### (Exterior Body)

The exterior body stores the wound body and the electrolyte (electrolytic solution). There is no particular limitation on the exterior body, and a known exterior body can be used. For example, the exterior body may be a cylindrical bottomed case and a sealing body that seals the case.

### (Manufacturing Method of Electrochemical Device)

An example of a manufacturing method of the electrochemical device (D3) will be described below. The electrochemical device (D3) may be manufactured by a method other than the method described below.

First, the components constituting the wound body are prepared. The first and second electrodes (or the electrode sheets to be those electrodes) can be formed by the method described above. If necessary, leads are connected to the electrodes (or the electrode sheets) in advance. Then, a winding step is performed. In the winding step, the first electrode, the second electrode, and the separator are wound so that the separator is interposed between the first electrode and the second electrode, thereby forming the wound body.

Before or during the winding step, a bending step is performed to bend a portion of the second electrode near a portion to be the outer peripheral end. There are no particular limitations on the method of the bending step, and any method may be used as long as it can be used to bend a portion of the second electrode near the outer peripheral end.

In an example of the bending step, in shearing a belt-shaped electrode sheet to be the second electrode to a predetermined length, the second electrode may be bent at the same time as the shearing. For example, the bent portion may be formed by shearing the electrode sheet with a certain gap intentionally provided between the lower mold and the upper mold. The first electrode can also be bent at a portion near the outer peripheral end by a similar method.

The steps after the formation of the wound body are not particularly limited, and the electrochemical device (D3) may be assembled by a known method. For example, the electrochemical device (D3) can be obtained by storing the wound body and the electrolyte in the exterior body.

Hereinafter, an example of an embodiment according to the present disclosure will be specifically described with reference to the drawings. The embodiment described below can be modified based on the above description. The matters described below may be applied to the above embodiment. In the embodiment described below, matters that are not essential to the invention according to the present disclosure may be omitted.

### First Embodiment

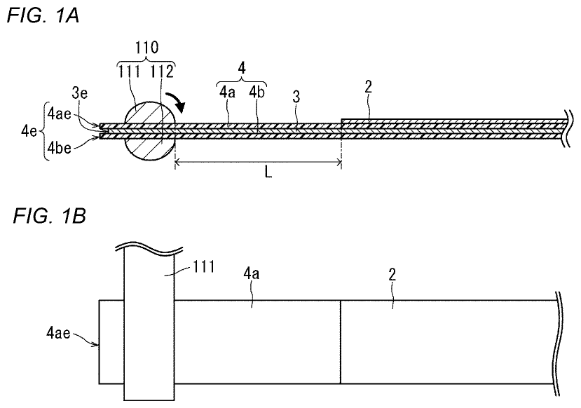

As a first embodiment, examples of the manufacturing method (M1) and the electrochemical device (D1) will be described. According to the manufacturing method and electrochemical device of the first embodiment, the above-described advantageous effects can be obtained. FIGS. 1A and 1B show one step of the manufacturing method of the first embodiment. FIG. 1A is a schematic cross-sectional view illustrating a portion of the step of producing the wound body. FIG. 1B is a top view of FIG. 1A.

In the manufacturing method of the first embodiment, first, as shown in FIG. 1A, a portion of one end 3e side of a negative electrode 3 and a portion of one end 4e side of a separator 4 are sandwiched between winding shafts 110 (first winding shaft 111 and second winding shaft 112). The winding shafts 110 includes a first winding shaft 111 and a second winding shaft 112. The first winding shaft 111 and the second winding shaft 112 are each a rod-shaped body having a semicircular cross section.

A belt-shaped positive electrode 2 includes a belt-shaped positive electrode current collector and a positive electrode mixture layer that is arranged on both surfaces of the positive electrode current collector. The belt-shaped negative electrode 3 includes a belt-shaped negative electrode current collector and a negative electrode mixture layer that is arranged on both surfaces of the negative electrode current collector. Leads (not shown) are connected to the positive electrode 2 and the negative electrode 3.

The belt-shaped separator 4 includes a belt-shaped first separator 4a and a belt-shaped second separator 4b. In the example shown in FIG. 1A, the first winding shaft 111 and the second winding shaft 112 sandwich the portion of the one end 3e side of the negative electrode 3, a portion of one end 4ae side of the first separator 4a, and a portion of one end 4be side of the second separator 4b. In the example shown in FIG. 1A, the portion of the one end 3e side of the negative electrode 3 and the portion of the one end 4e side of the separator 4 are sandwiched between the first winding shaft 111 and the second winding shaft 112 such that the one end 3e of the negative electrode 3 and the one end 4e of the separator 4 protrude from between the first winding shaft 111 and the second winding shaft 112. The positive electrode 2 is not sandwiched between the first winding shaft 111 and the second winding shaft 112.

Next, the winding shafts 110 are rotated while a portion of the negative electrode 3 and a portion of the separator 4 are sandwiched between the winding shafts 110, thereby to form a wound body. In an example of the first embodiment, the winding shafts 110 are rotated in the direction of the arrow in FIG. 1A to form a wound body. At this time, the positive electrode 2 is also wound together with the negative electrode 3 and the separator 4, thereby to form a wound body including them. The end of the outermost separator 4 and/or the end of the outermost negative electrode 3 may be fixed with tape.

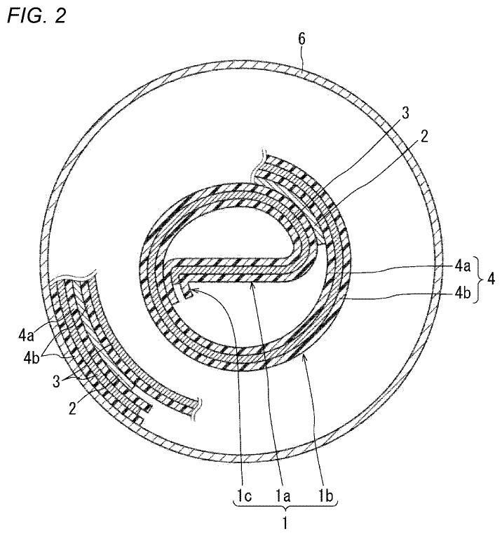

FIG. 2 is a cross-sectional view of a formed wound body 1 that is placed in an exterior case 6. However, FIG. 2 does not show a portion of the wound body 1. In the drawings, the ratio of size of each member is changed from the actual ratio to facilitate understanding. For example, the actual ratio of thickness of each member constituting the wound body 1 to the size of the exterior case 6 is smaller than the ratio shown in FIG. 2. That is, FIG. 2 shows each member constituting the wound body 1 so as to be thicker than the actual thickness.

The wound body 1 shown in FIG. 2 includes a winding shaft part 1a that is formed by being sandwiched between the winding shafts 110 (first and second winding shafts 111 and 112) and a winding part 1b that is connected to the winding shaft part 1a. The winding part 1b is a part in which the components of the wound body 1 are wound. The winding shaft part 1a includes a portion of the one end 3e side of the negative electrode 3 and a portion of the one end 4e side of the separator 4. The winding shaft part 1a exemplified in the first embodiment does not include a positive electrode 2.

The members constituting the winding shaft part 1a (including at least the negative electrode 3 and the separator 4) are generally integral, but do not have to be integral. The winding shaft part 1a usually extends radially across the central circular hollow portion in a cross section perpendicular to the central axis of the wound body 1 (cross section shown in FIG. 2).

The negative electrode 3 is present inside the innermost periphery of the positive electrode 2 and outside the outermost periphery of the positive electrode 2. Therefore, in the wound body 1, both surfaces of the positive electrode 2 face the negative electrode 3. As an example of a method for arranging the negative electrode 3 inside the innermost periphery of the positive electrode 2, in performing the winding shown in FIG. 1A, a length L from the winding shafts 110 to one end of the positive electrode 2 may be made larger than the periphery of the winding shafts 110. In the example of the first embodiment, the separator 4 is present at the outermost periphery, and the electrode plate and the exterior case 6 are not in contact with each other.

As shown in FIG. 2, the wound body 1 exemplified in the first embodiment further includes a protrusion 1c that is connected to the winding shaft part 1a on the side opposite to the winding part 1b. The protrusion 1c includes the one end 3e of the negative electrode 3. The negative electrode 3 and the separator 4 are bent in front of and behind the winding shaft part 1a.

The outer peripheral end of the separator 4 and/or the outer peripheral end of the negative electrode 3 may be fixed with tape. Fixing the outer peripheral ends with tape makes it possible to fix the start and end of the wound body 1. This particularly suppresses loosening of the wound body 1.

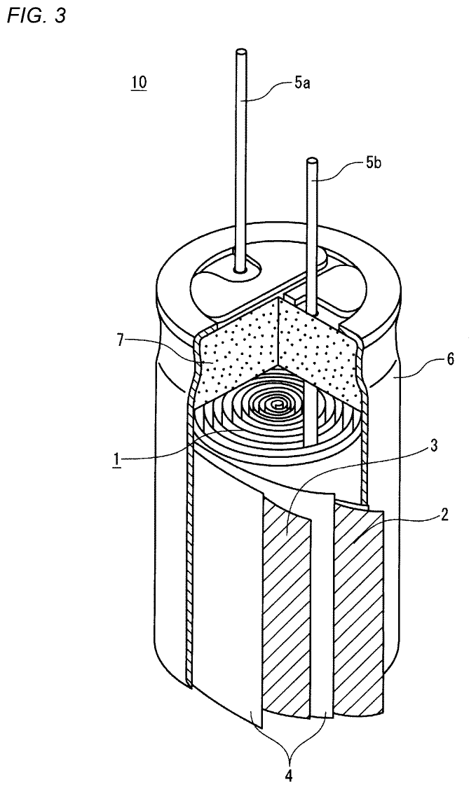

An example of an electrochemical device using the wound body 1 is shown in FIG. 3. FIG. 3 is a partially cutaway perspective view of an electrochemical device 10 according to the first embodiment.

The electrochemical device 10 shown in FIG. 3 is an electrical double layer capacitor. The electrochemical device 10 includes the wound body (capacitor element) 1. A lead wire 5a is connected to the positive electrode 2, and a lead wire 5b is connected to the negative electrode 3. The wound body 1 is stored in the cylindrical exterior case 6 together with an electrolyte (not shown). The material of the exterior case 6 may be a metal such as aluminum, stainless steel, copper, iron, or brass, for example. The opening of the exterior case 6 is sealed with a sealing member 7. The lead wires 5a and 5b are led out to the outside so as to pass through the sealing member 7. The sealing member 7 can be made of an elastic member such as rubber (for example, butyl rubber).

### Second Embodiment

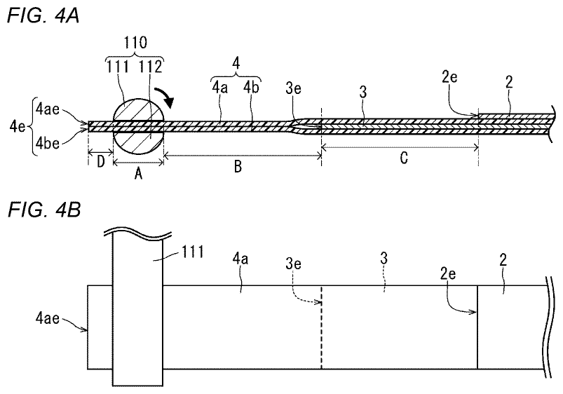

As a second embodiment, examples of the manufacturing method (M2) and the electrochemical device (D2) will be described. According to the manufacturing method and electrochemical device of the second embodiment, the above-described advantageous effects can be obtained. FIGS. 4A and 4B show one step of the manufacturing method of the second embodiment. FIG. 4A is a cross-sectional diagram that schematically shows a portion of the step of producing a wound body. FIG. 4B is a top view of FIG. 4A.

In the manufacturing method of the second embodiment, first, as shown in FIG. 4A, a portion of one end 4e side of a separator 4 is sandwiched between winding shafts 110 (first winding shaft 111 and second winding shaft 112). The winding shafts 110 includes a first winding shaft 111 and a second winding shaft 112. Each of the first winding shaft 111 and the second winding shaft 112 is a rod-shaped body having a semicircular cross section with a diameter of length A.

A belt-shaped positive electrode 2 includes a belt-shaped positive electrode current collector and a positive electrode mixture layer that is arranged on both surfaces of the positive electrode current collector. A belt-shaped negative electrode 3 includes a belt-shaped negative electrode current collector and a negative electrode mixture layer that is arranged on both surfaces of the negative electrode current collector. Leads (not shown) are connected to the positive electrode 2 and the negative electrode 3.

A belt-shaped separator 4 includes a belt-shaped first separator 4a and a belt-shaped second separator 4b. In the example shown in FIG. 4A, the first winding shaft 111 and the second winding shaft 112 sandwich a portion of one end 4ae side of the first separator 4a and a portion of one end 4be side of the second separator 4b. In the example shown in FIG. 4A, a portion of one end 4e side of the separator 4 is sandwiched between the first winding shaft 111 and the second winding shaft 112 so that the one end 4e of the separator 4 protrudes by a length D (mm) from between the first winding shaft 111 and the second winding shaft 112. The positive electrode 2 and the negative electrode 3 are not sandwiched between the first winding shaft 111 and the second winding shaft 112. The negative electrode 3 is interposed between the first separator 4a and the second separator 4b.

Referring to FIG. 4A, the distance between the one end 3e of the negative electrode 3 close to the winding shafts 110 and the winding shafts 110 is defined as distance B (mm). The distance between the one end 2e of the positive electrode 2 and the one end 3e of the negative electrode 3, which are close to the winding shafts 110, is defined as distance C (mm). The above description applies to the relationship among the length A, the distance B, the distance C, the length D, the average thickness T1, and the average thickness T2. Note that the length A, the distance B, the distance C, and the length D are the lengths and distances in the state of FIG. 4A. In measuring these lengths and distances in the formed wound body, the wound body may be developed flat. Alternatively, these lengths and distances may be measured along the circumferential direction of the wound body in an image of the end face or cross section of the wound body.

Next, the winding shafts 110 are rotated while a portion of the separator 4 is sandwiched between the winding shafts 110, thereby to form a wound body. In an example of the second embodiment, the winding shafts 110 are rotated in the direction of the arrow in FIG. 4A to form a wound body. At this time, the positive electrode 2 is also wound together with the negative electrode 3 and the separator 4 to form a wound body including them.

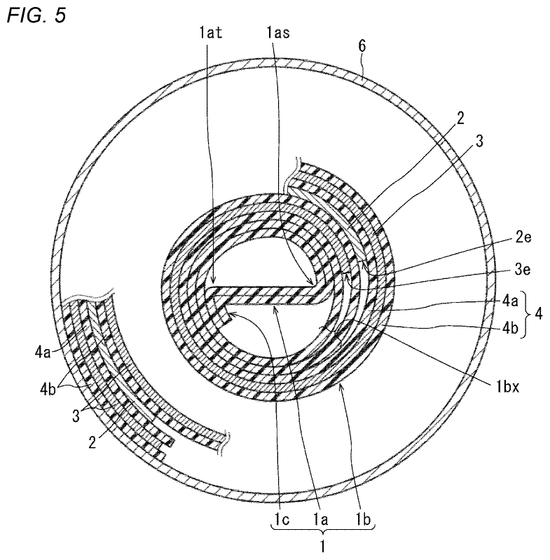

FIG. 5 is a cross-sectional view of the formed wound body 1 that is placed in an exterior case 6. However, FIG. 5 does not show a portion of the wound body 1. In the drawings, the ratio of the size of each member is changed from the actual ratio to facilitate understanding. For example, the actual ratio of thickness of each member constituting the wound body 1 to the size of the exterior case 6 is smaller than the ratio shown in FIG. 5. That is, FIG. 5 shows each member constituting the wound body 1 so as to be thicker than the actual thickness.

The wound body 1 shown in FIG. 5 includes a winding shaft part 1a that is formed by being sandwiched between winding shafts 110 (first and second winding shafts 111 and 112) and a winding part 1b that is connected to the winding shaft part 1a. The winding part 1b is a part in which the components of the wound body 1 are wound.

The winding shaft part 1a is constituted only of the separator 4 (first and second separators 4a and 4b). The winding shaft part 1a includes a first end 1as that is a boundary with the winding part 1b, and a second end 1at that is opposite to the first end 1as. The wound body 1 includes a protrusion 1c that is constituted only of the first and second separators 4a and 4b and protrudes from the second end 1at. Due to the presence of the protrusion 1c, the separator 4 is bent in front of and behind the winding shaft part 1a.

The winding part 1b includes a reinforcement part 1bx in which only the first and second separators 4a and 4b are wound one or more turns between the first end 1 as and the one end 3e of the negative electrode 3 close to the winding shaft part. In the example shown in FIG. 5, the number of turn n is one. The reinforcement part 1bx may be formed by winding only the first and second separators 4a and 4b one or more turns. The reinforcement part may be formed by winding only the first and second separators 4a and 4b three or less turns, or two or less turns.

The members constituting the winding shaft part 1a (separators 4a and 4b) are generally integral, but do not have to be integral. The winding shaft part 1a usually extends radially across the central circular hollow portion in a cross section perpendicular to the central axis of the wound body 1 (cross section shown in FIG. 5).

The negative electrode 3 is present inside the innermost periphery of the positive electrode 2 and outside the outermost periphery of the positive electrode 2. Therefore, in the wound body 1, both surfaces of the positive electrode 2 face the negative electrode 3. As an example of a method for arranging the negative electrode 3 inside the innermost periphery of the positive electrode 2, in performing the winding shown in FIG. 4A, the distance C may be made longer than the peripheral length of the wound body present inside the positive electrode 2. For example, the above-described condition (b) may be satisfied. In the example of the second embodiment, the separator 4 is present at the outermost periphery, and the electrode plate and the exterior case 6 are not in contact with each other.

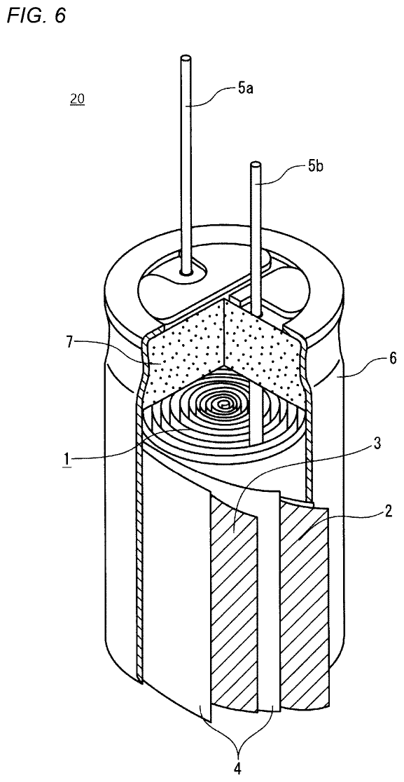

An example of an electrochemical device using the wound body 1 is shown in FIG. 6. FIG. 6 is a partially cutaway perspective view of an electrochemical device 20 according to the second embodiment.

The electrochemical device 20 shown in FIG. 6 is an electrical double layer capacitor. The electrochemical device 20 includes a wound body (capacitor element) 1. A lead wire 5a is connected to a positive electrode 2, and a lead wire 5b is connected to a negative electrode 3. The wound body 1 is stored in a cylindrical exterior case 6 together with an electrolyte (not shown). The material of the exterior case 6 may be a metal such as aluminum, stainless steel, copper, iron, or brass. The opening of the exterior case 6 is sealed with a sealing member 7. The lead wires 5a and 5b are led out to the outside so as to pass through the sealing member 7. The sealing member 7 may be made of an elastic member such as rubber (for example, butyl rubber).

### Third Embodiment

In a third embodiment, an example of an electrochemical device (D3) and a manufacturing method of the same will be described. According to the electrochemical device of the third embodiment, the above-described advantageous effects can be obtained.

A partial cross-sectional view of an example of a wound body of the electrochemical device (D3) of the third embodiment is shown in FIG. 7. FIG. 7 shows a wound body 1 that is stored in an exterior case 6. FIG. 7 shows only a portion of the outer periphery of the wound body 1.

The wound body 1 shown in FIG. 7 is formed by winding a belt-shaped first electrode 2, a belt-shaped second electrode 3, and a separator 4. The separator 4 is interposed between the first electrode 2 and the second electrode 3. The separator 4 includes a first separator 4a and a second separator 4b.

As shown in FIG. 7, the outermost periphery of the second electrode 3 is arranged outside the outermost periphery of the first electrode 2. In addition, the separator 4 is present outside the outermost periphery of the second electrode 3. Therefore, the second electrode 3 and the exterior case 6 are not in contact with each other.

A portion of the second electrode 3 near the outer peripheral end 3e is bent, so that the outer peripheral end 3e is in abutment with the separator 4. Specifically, the outer peripheral end 3e is in oblique abutment with the surface of the separator 4. With this configuration, the above-described advantageous effects can be obtained.

The outer peripheral end 3e faces the second electrode 3 inside, with the stacked first separator 4a and second separator 4b in between. With this configuration, even if the outer peripheral end 3e damages the separator, it is possible to prevent a short circuit between the first electrode 2 and the second electrode 3.

There is no limitation on the method of folding the outer peripheral end 3e. For example, a portion near the outer peripheral end 3e may be pinched and bent with a jig or the like. Accordingly, as shown in FIG. 8, it is possible to form a bent portion 3c of the second electrode 3 near the outer peripheral end 3e. The bent portion 3c extends linearly along a direction perpendicular to the longitudinal direction of the second electrode 3 (a direction parallel to the outer peripheral end 3e). As described above, a distance L from the outer peripheral end 3e to the bent portion 3c may be in a range of 0.01 to 0.5 mm. An angle α at which the second electrode 3 is bent at the bent portion 3c can be in the range described above.

When the formed second electrode 3 is wound together with other members (the first electrode 2 and the separator 4) in the direction of arrow A in FIG. 8, the bent portion 3c is bent toward the inside of the wound body. When the formed second electrode 3 is wound together with other members (the first electrode 2 and the separator 4) in the direction of arrow B in FIG. 8, the bent portion 3c is bent toward the outside of the wound body. In this manner, the wound body is formed.

Leads may be connected in advance to the wound first electrode 2 and second electrode 3. The outermost separator 4 of the wound body may be fixed with tape.

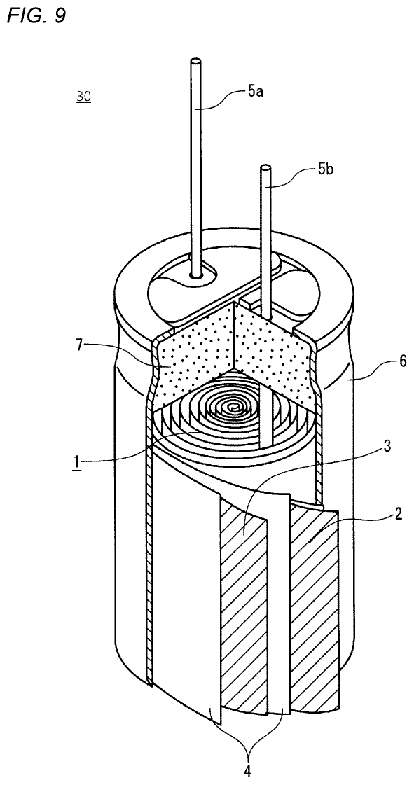

An example of an electrochemical device using the wound body 1 is shown in FIG. 9. FIG. 9 is a partially cutaway perspective view of an electrochemical device 30 according to the third embodiment.

The electrochemical device 30 shown in FIG. 9 is an electrical double layer capacitor. The electrochemical device 30 includes the wound body (capacitor element) 1. A lead wire 5a is connected to the first electrode 2, and a lead wire 5b is connected to the second electrode 3. The wound body 1 is stored in a cylindrical exterior case 6 together with an electrolyte (not shown). The material of the exterior case 6 may be a metal such as aluminum, stainless steel, copper, iron, or brass, for example. The opening of the exterior case 6 is sealed with a sealing member 7. The lead wires 5a and 5b are led out to the outside so as to pass through the sealing member 7. The sealing member 7 can be formed of an elastic member such as rubber (for example, butyl rubber). As described above, a portion of the second electrode 3 near the outer peripheral end is bent.

### INDUSTRIAL APPLICABILITY

The present disclosure can be used for electrochemical devices and manufacturing methods of the same.

Although the present invention has been described with respect to the presently preferred embodiments, such a disclosure should not be interpreted as limiting. Various modifications and alterations will undoubtedly become apparent to those skilled in the art to which the present invention pertains upon reading the above disclosure. Therefore, the appended claims should be interpreted to cover all modifications and alterations without departing from the true spirit and scope of the present invention.

### REFERENCE SIGNS LIST

1: wound body, 1a: winding shaft part, 1b: winding part, 1bx: reinforcement part, 1c: protrusion, 2: positive electrode, first electrode, 3: negative electrode, second electrode, 3c: bent portion, 3e: outer peripheral end, 4: separator, 4a: first separator, 4b: second separator, 10: electrochemical device (first electrochemical device), 20: electrochemical device (second electrochemical device), 30: electrochemical device (third electrochemical device), 110: winding shaft, 111: first winding shaft, 112: second winding shaft

1. A manufacturing method of an electrochemical device that includes a wound body constituted of a belt-shaped positive electrode containing active carbon as a positive electrode material, a belt-shaped negative electrode, and a belt-shaped separator interposed between the positive electrode and the negative electrode,
wherein the manufacturing method comprises:
sandwiching a portion of one end side of the negative electrode and a portion of one end side of the separator between a first winding shaft and a second winding shaft; and
forming the wound body by rotating the first winding shaft and the second winding shaft while the portion of the negative electrode and the portion of the separator are sandwiched between the first winding shaft and the second winding shaft, thereby to wind the positive electrode, the negative electrode, and the separator, the sandwiching and the forming being performed in this order, and
during the forming of the wound body, the positive electrode, the negative electrode, and the separator are wound such that both surfaces of the positive electrode face the negative electrode.

2. The manufacturing method according to claim 1, wherein during the sandwiching, the portion of the negative electrode and the portion of the separator are sandwiched between the first winding shaft and the second winding shaft such that the one end of the negative electrode protrudes from between the first winding shaft and the second winding shaft.

3. The manufacturing method according to claim 1, wherein during the sandwiching, the positive electrode is not sandwiched between the first winding shaft and the second winding shaft.

4. An electrochemical device comprising a wound body that is constituted of a belt-shaped positive electrode containing active carbon as a positive electrode active material, a belt-shaped negative electrode, and a belt-shaped separator interposed between the positive electrode and the negative electrode,
wherein the wound body includes a winding shaft part that is formed by being sandwiched between winding shafts and a winding part that is connected to the winding shaft part,
the winding shaft part includes a portion of one end side of the negative electrode and a portion of one end side of the separator, and
the positive electrode, the negative electrode, and the separator are wound in the wound body such that both surfaces of the positive electrode face the negative electrode.

5. The electrochemical device according to claim 4,
wherein the wound body further includes a protrusion that is connected to the winding shaft part on a side opposite to the winding part, and
the protrusion includes the one end of the negative electrode.

6. The electrochemical device according to claim 4, wherein the winding shaft part does not include the positive electrode.

7. A manufacturing method of an electrochemical device that includes a wound body constituted of a belt-shaped positive electrode containing active carbon as a positive electrode material, a belt-shaped negative electrode, and a belt-shaped separator interposed between the positive electrode and the negative electrode,
wherein the separator includes a belt-shaped first separator and a belt-shaped second separator,
the manufacturing method comprises:
sandwiching only a portion of one end side of the first separator and a portion of one end side of the second separator between winding shafts; and
forming the wound body by rotating the winding shafts while maintaining a state of the sandwiching to wind the positive electrode, the negative electrode, and the first and second separators,
the winding shafts are constituted of first and second winding shafts each having a semicircular cross section with a diameter of length A,
the first separator has an average thickness T1,
the second separator has an average thickness T2, and
during the forming of the wound body, the winding is performed such that:
(a) a distance B between one end of the negative electrode close to the winding shafts and the winding shafts and the length A satisfy πA<B; and
(b) a distance C between one end of the positive electrode close to the winding shafts and the one end of the negative electrode, the length A, the average thickness T1, and the average thickness T2 satisfy π(A+(T1+T2)×2n)<C (where n is the number of turns by which only the first and second separators are wound).

8. The manufacturing method according to claim 7, wherein during the forming of the wound body, the winding is performed while the distance B and the length A satisfy 2πA<B.

9. The manufacturing method according to claim 7, wherein during the forming of the wound body, the wound body is formed such that both surfaces of the positive electrode face the negative electrode.

10. An electrochemical device comprising a wound body that is constituted of a belt-shaped positive electrode containing active carbon as a positive electrode active material, a belt-shaped negative electrode, and a belt-shaped separator interposed between the positive electrode and the negative electrode,
wherein the separator includes a belt-shaped first separator and a belt-shaped second separator,
the wound body includes a winding shaft part that is formed by being sandwiched between winding shafts and a winding part that is connected to the winding shaft part,
the winding shaft part is constituted only of the first and second separators,
the winding shaft part includes a first end that is a boundary with the winding part and a second end that is opposite to the first end,
the winding part includes a reinforcement part in which only the first and second separators are wound one or more turns between the first end and one end of the negative electrode close to the winding shaft part, and
in the wound body, a surface of the positive electrode close to the winding shaft part faces the negative electrode.

11. The electrochemical device according to claim 10, wherein in the reinforcement part, only the first and second separators are wound two or more turns.

12. The electrochemical device according to claim 10, wherein both surfaces of the positive electrode face the negative electrode.

13. The electrochemical device according to claim 10, wherein the wound body includes a protrusion that is constituted of only the first and second separators and protrudes from the second end.

14. An electrochemical device comprising a wound body that is constituted of a belt-shaped first electrode, a belt-shaped second electrode, and a belt-shaped separator interposed at least between the first electrode and the second electrode,
wherein an outermost periphery of the second electrode is arranged outside an outermost periphery of the first electrode, and
a portion of the second electrode near an outer peripheral end is bent so that the outer peripheral end of the second electrode is in abutment with the separator.

15. The electrochemical device according to claim 14,
wherein a portion of the second electrode near the outer peripheral end is bent toward inside of the wound body, and
the outer peripheral end of the second electrode is in abutment with the separator present inside the outer peripheral end of the second electrode.

16. The electrochemical device according to claim 14, wherein the second electrode has a portion that is bent in a range of 0.01 mm to 0.5 mm from the outer peripheral end of the second electrode.

17. The electrochemical device according to claim 14, wherein a portion of the first electrode near an outer peripheral end is bent and the outer peripheral end of the first electrode is in abutment with the separator.
